(19) United States
(12) Patent Application Publication
(10) Pub. No.: US 2023/0007913 A1
(43) Pub. Date: Jan. 12, 2023

(54) RENDERING OF UNSAFE WEBPAGES

(71) Applicant: Hewlett-Packard Development Company, L.P., Spring, TX (US)

(72) Inventors: Chee Keat Fong, Spring, TX (US); Valiuddin Ali, Spring, TX (US)

(73) Assignee: Hewlett-Packard Development Company, L.P., Spring, TX (US)

(21) Appl. No.: 17/783,301

(22) PCT Filed: Jan. 7, 2020
(86) PCT No.: PCT/US2020/012623

§ 371 Date: Jun. 8, 2022

(51) Int. Cl. H04L 9/40

(52) U.S. Cl. CPC H04L 63/1483; H04L 63/1416

(57) ABSTRACT

An example non-transitory computer readable storage medium comprising instructions that when executed cause a processor of a computing device to: in response to receiving a first request to access a webpage, transmit a second request to an monitoring resource to determine if the webpage is unsafe; receive, from the monitoring resource, an indication that the webpage is an unsafe webpage; and in response to receiving the indication, render, at the computing device, a modified copy of the webpage with every active element of the webpage disabled.

### BACKGROUND

Phishing continues to be a major attack vector used by cyber criminals to lure unsuspecting users to infected or malicious webpages in order to deliver malware or steal sensitive personal information from the users.

### BRIEF DESCRIPTION OF THE DRAWINGS

Some examples of the present application are described with respect to the following figures:

FIG. 1 illustrates an electronic device to render a webpage with an active element disabled, according to an example;

FIG. 2 illustrates an electronic device to render a webpage with an active element disabled, according to another example;

FIG. 3 illustrates a rendering of a webpage with an active element disabled, according to an example;

FIG. 4 illustrates a rendering of a we with an active element; disabled and a warning message, according to an example;

FIG. 5A illustrates a rendering of a webpage with an option to enable a disabled active element, according to an example;

FIG. 5B illustrates a rendering of the webpage of FIG. 5A with the active element enabled, according to an example;

FIG. 6A illustrates a rendering of a webpage with an option to enable a disabled active element, according to another example;

FIG. 6B illustrates a rendering of the webpage of FIG. 6A with the active element enabled, according to another example;

FIG. 7 illustrates a method of rendering a webpage with an active element disabled, according to an example; and

FIG. 8 illustrates a computing device to render a webpage with an active element disabled, according to an example.

### DETAILED DESCRIPTION

One form of phishing attack is using a fake webpage that mimics the look of a legitimate webpage in order to direct a user to enter personal information in the fake webpage. Examples described herein provide an approach to render an unsafe webpage so that a user may see the content of the webpage while reducing the likelihood of exposing the user's device to potential harmful content. In an example, a non-transitory computer readable storage medium may include instructions that when executed cause a processor of a computing device to: in response to receiving a first request to access a webpage, transmit a second request to an monitoring resource to determine if the webpage is safe; receive, from the monitoring resource, an indication that the webpage is an unsafe webpage; and in response to receiving the indication, render, at the computing device, a modified copy of the webpage with every active element of the webpage disabled.

In another example, a non-transitory computer-readable storage medium may include instructions that when executed cause a processor of a computing device to: in response to receiving a first request to access a webpage, transmit a second request to an monitoring resource to determine if the webpage is unsafe; receive, from the monitoring resource, an indication that the webpage is an unsafe webpage; and in response to receiving the indication obtain a copy of the webpage from a hosting server; identify a text field in the webpage; and render, at the computing device, a modified copy of the webpage with the text field disabled.

In another example, a non-transitory computer-readable storage medium may include instructions that when executed cause a processor of a computing device to: in response to receiving a first request to access a webpage, transmit a second request to an monitoring resource to determine if the webpage is unsafe, where the webpage includes a first active element and a second active element; receive, from the monitoring resource, an indication that the webpage is an unsafe webpage; and in response to receiving the indication, render, at the computing device, a modified copy of the webpage based on user preference information, where the modified copy includes an enabled first active element and a disabled second active element. Thus, examples described herein may enable a webpage to be rendered with active element(s) disabled so that a user may be able to see the content of the webpage while reducing the likelihood of exposing the user's device to potential harmful content.

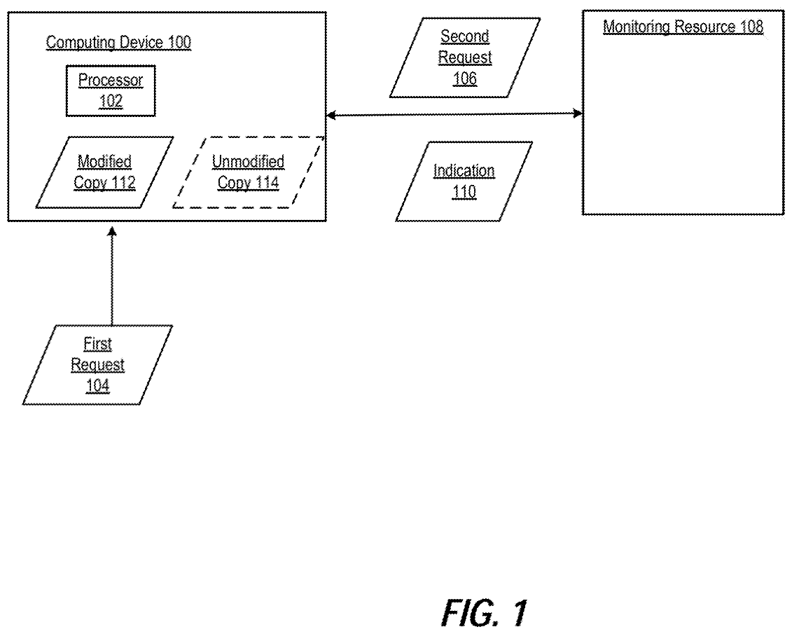

Turning to FIG. 1, FIG. 1 illustrates an electronic device 100 to render a webpage with an active element disabled, according to an example. Computing device 100 may be, for example, a web-based server, a local area network server, a cloud-based server, a notebook computer, a desktop computer, an all-in-one system, a tablet computing device, a mobile phone, an electronic book reader, or any other electronic device suitable for rendering a webpage for display. Computing device 100 may include a processor 102. Processor 102 may control operations of computing device 100.

During operation, computing device 100 may receive a first request 104 to access a webpage. For example, first request 104 may be received from a user of computing device 100 via an input device of computing device 100 (e.g., a keyboard). The user may type the location of the webpage in a web browser application running on computing device 100.

In response to receiving first request 104, computing device 100 may transmit a second request 106 to a monitoring resource 108 to determine if the webpage is unsafe. Monitoring resource 108 may perform analysis of a particular webpage and determine if the webpage is unsafe (e.g., a fake webpage that mimics a legitimate webpage, a webpage with embedded malicious code, etc.). Monitoring resource 108 may be implemented as a service, an application, a database, etc. In some examples, monitoring resource 108 may be implemented at a device that is separate from computing device 100, such as a server or a computing cloud environment. In some examples, monitoring resource 108 may be implemented within computing device 100. Monitoring resource 108 may utilize different techniques to determine if a webpage is unsafe (e.g., blacklist, artificial intelligence, malicious code signature detection, etc.).

After monitoring resource 108 analyzes the webpage, monitoring resource 108 may transmit an indication 110 to computing device 100 to inform computing device 100 if the webpage is unsafe. In response to receiving indication 110 that indicates the webpage is unsafe, computing device 100 may render a modified copy of the webpage 112 with every active element of the webpage disabled. In response to receiving indication 110 that indicates the webpage is not unsafe, computing device 100 may render an unmodified copy of the webpage 114.

As used herein, an active element may be a component of a webpage that triggers an action to occur at a computing device in response to an input or the component being rendered. An example active element may include a hyperlink. When a user clicks on a hyperlink, the clicking of the hyperlink may cause another webpage to be rendered or content (e.g., a script or a file) to be downloaded. Another example active element may include a script or applet that is embedded in a webpage, such as embedded in an image of the webpage. The script may cause a computing device to download executable code or cause the computing device to display graphic content Another example active element may include a text field, where a user may input information. In some examples, an active element may correspond to an interactive element defined under the Hypertext Markup Language (HTML) specification.

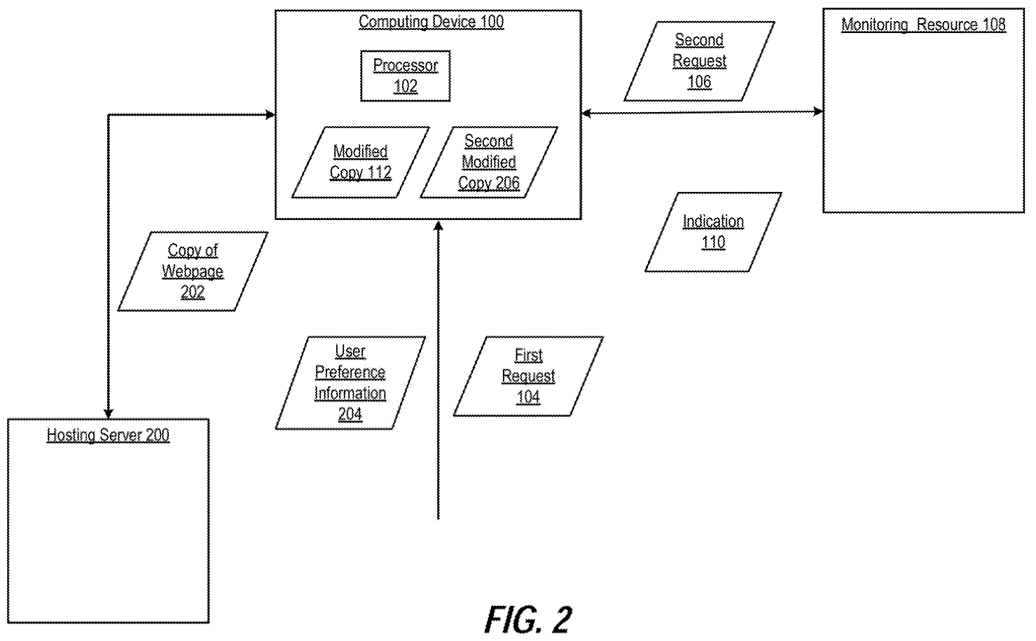

FIG. 2 illustrates electronic device 100 to render a webpage with an active element disabled, according to another example. During operation, in response to receiving indication 110, computing device 100 may request a copy of the webpage 202 from a hosting server 200 where the webpage is hosted. In response to receiving copy 202 of the webpage, computing device 100 may render modified copy 112 based on copy 202. Compared to copy 202, modified copy 112 may retain content of copy 202 while active elements of the webpage are disabled. That is, modified copy 112 retain inert elements of the webpage while the active elements are disabled. Computing device 100 may display modified copy 112 via the web browser application,

In some examples, computing device 100 may render modified copy 112 based on copy 202 and user preference information 204. User preference information 204 may indicate how a webpage is to be rendered. For example, user preference information 204 may indicate that a particular type of active element (e.g., script) is disabled while other types of active elements (e.g., image) are enabled. As another example, user preference information 204 may indicate that active elements of a webpage from a particular location are enabled and active elements of a webpage from other locations are disabled. A location may include an Internet Protocol address, a uniform resource locator (URL), a domain, a subdomain, etc. In some examples, user preference information 204 may be stored in computing device 100. In some examples, computing device 100 may retrieve user preference information 204 from another device.

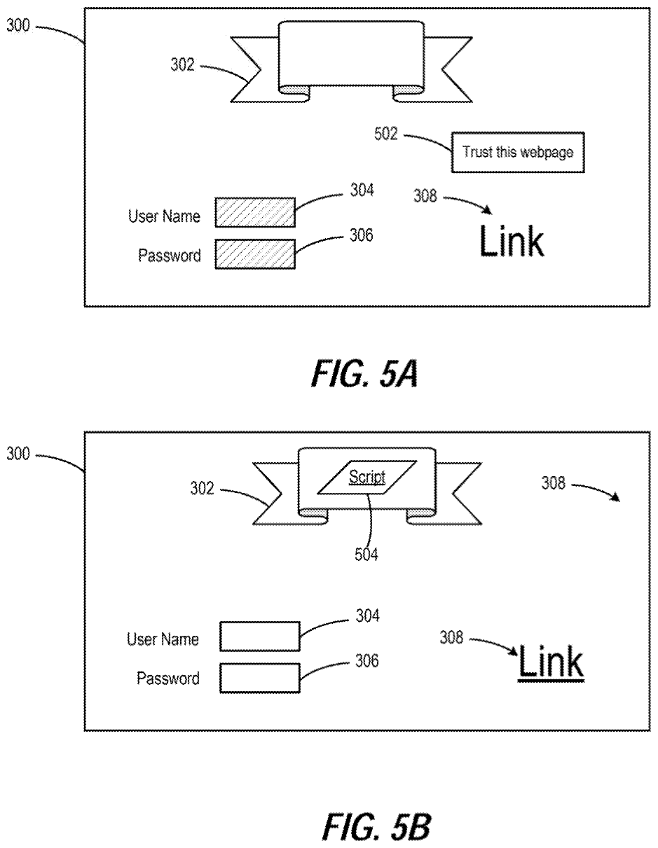

As described in more details in FIGS. 5A, 5B, 6A, and 58, computing device 100 may give the user the option to manually enable some or all of the active elements after rendering modified copy 112. In response to receiving a command from the user to re-render with some or all of the active elements enabled, computing device 100 may render a second modified copy of the webpage 206 based on copy 202 and/or modified copy 112.

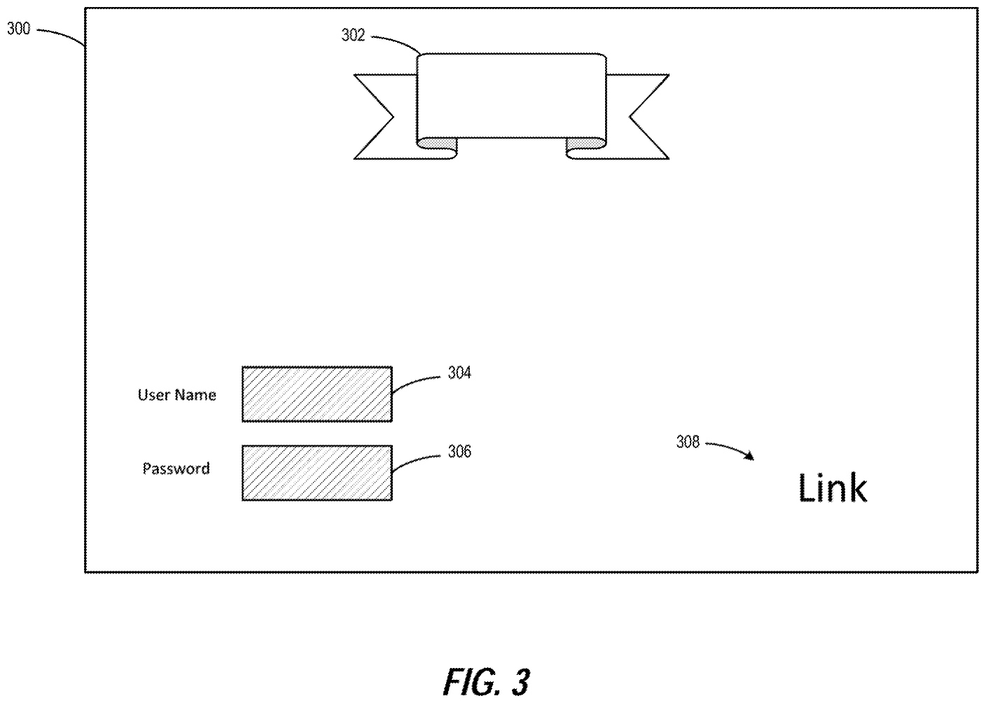

FIG. 3 illustrates a rendering of a webpage 300 with an active element disabled, according to an example. Webpage 300 may be an example of modified copy of webpage 112 of FIGs.1 and 2. Webpage 300 may include a first active element 302, a second active element 304, a third active element 306, and a fourth active element 308. First active element 302 may be an image with an embedded script. Second active element 304 and third active element 306 may be text fields, such as a user name field and a password field. Fourth active element 308 may be a hyperlink. As illustrated in FIG. 3, active elements 302, 304, 306, and 308 may be disabled. In some examples, first active element 302 may be rendered as a plain image with the embedded script disabled. Second active element 304 and third active element 306 may be rendered as plain text and the actual text fields greyed out so that a user may not be able to enter information in either text field. Fourth active element 308 may be rendered as plain text. Thus, when a user tries to click on the plain text, the reference location linked may not be able to be triggered.

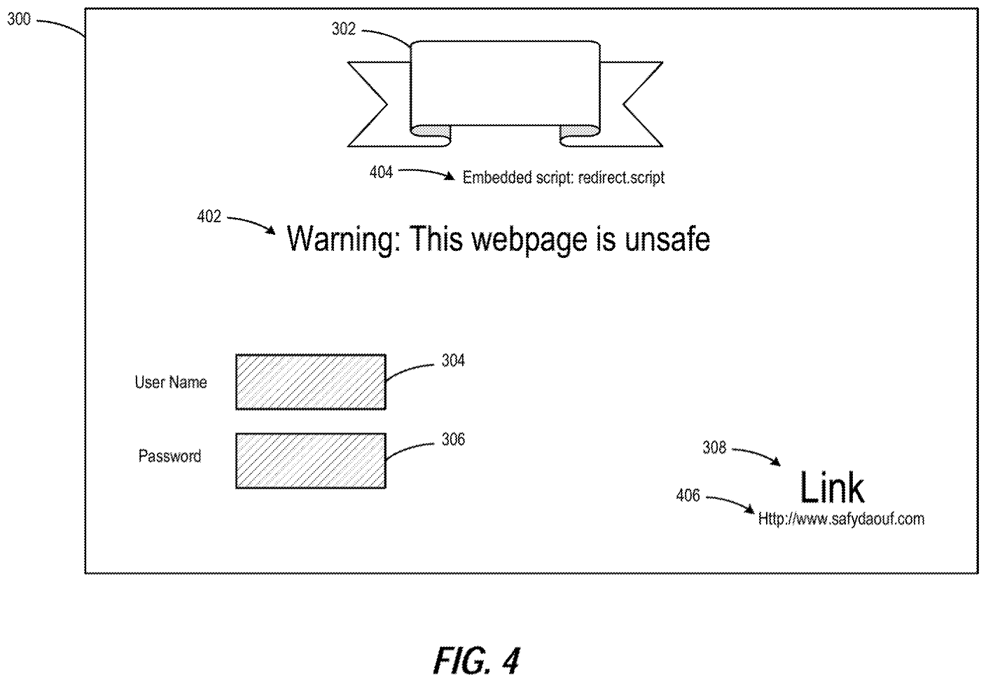

FIG. 4 illustrates a rendering of webpage 300 with an active element disabled and a warning message, according to an example. As illustrated in FIG. 3, webpage 300 may be rendered to show a warning message 402 to inform the user that webpage is unsafe. Webpage 300 may also include a first message 404 to display information about the script embedded in first active element 302, Webpage 300 may further include a second message 406 to display information about the referenced location in fourth active element 308. Thus, the user may be able to view the full content of webpage 300 while avoiding exposing computing device 100 to harmful content. In some examples, warning message 402 may be displayed as a pop-up message after webpage 300 is loaded. The pop-up message may be dismissed by the user subsequently. In some examples, warning message 402 may be displayed within a browser toolbar as a status.

FIG. 5A illustrates a rendering of webpage 300 with an option to enable a disabled active element, according to an example. As illustrated in FIG. 5A, webpage 300 may be rendered with the active elements 302, 304, 306, and 308 disabled. Webpage 300 may also be rendered with an option 502 to allow a user to enable disabled active elements 302, 304, 306, and 308. Option 502 may be rendered as a clickable button or other interactive element of a webpage. Turning to FIG. 58, in response to a selection of option 502 (e.g., via a touch input or a mouse click from a user), webpage 300 may be re-rendered with active elements 302, 304, 306, and 308 enabled. Thus, a script 504 embedded in first active element 302 may be rendered or loaded as part of first active element 302. Script 504 may also be executed when first active element 302 is rendered as enabled. Active elements 304 and 306 may receive input from a user (e.g. via a keyboard). Fourth active element 308 may cause a referenced webpage to open when clicked on. In some examples, option 502 may be displayed as a user interface element within a browser, such as a button.

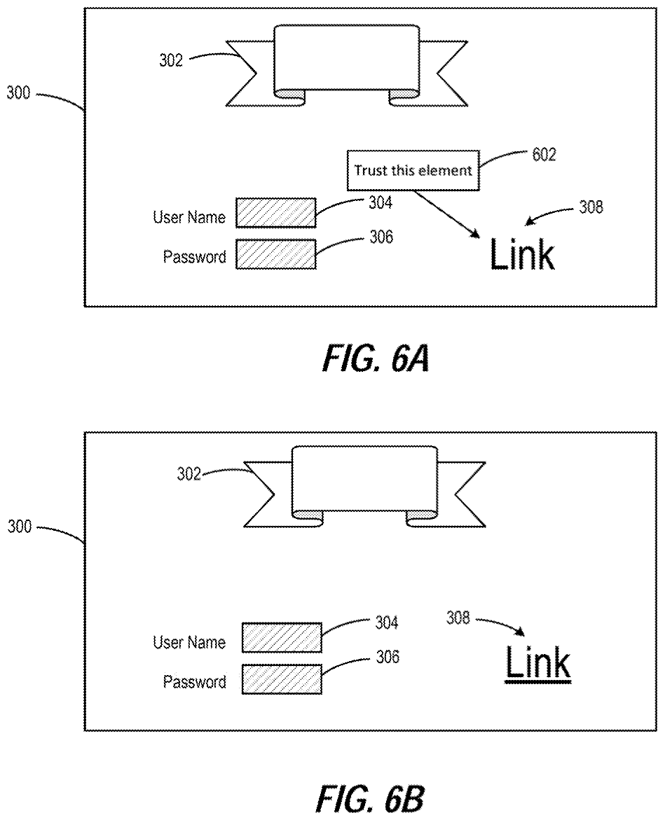

In some examples, webpage 300 may provide an option to enable an individual active element, as described in more detail in FIGS. 6A-6B. Turning to FIG. 6A, webpage 300 may be rendered with active elements, 302, 304, 306, and 308 disabled. Webpage 300 may also be rendered with an option 602 to allow a user to enable a particular active element, such as fourth active element 308. Turning to FIG. 68, in response to a selection of option 602, fourth active element 308 may be enabled while active elements 302, 304, and 306 remain disabled. In some examples, computing device 100 may update user preference information 204 to indicate fourth active element 308 is to be rendered as enabled in a subsequent rendering of webpage 300 at computing device 100.

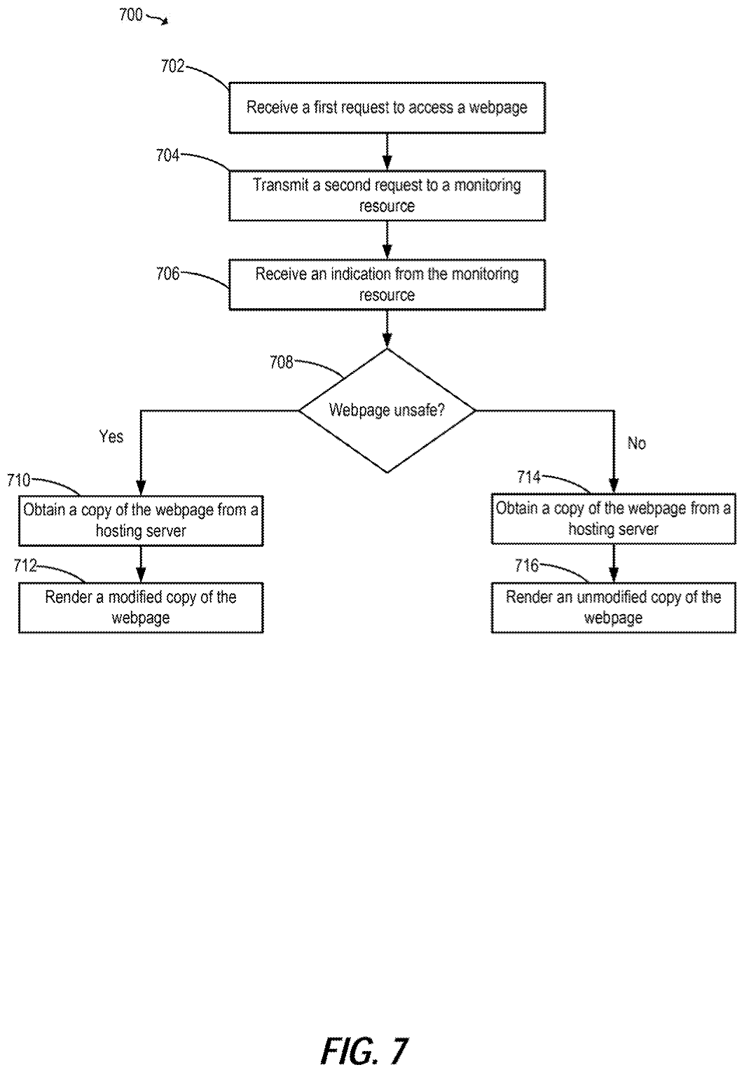

FIG. 7 illustrates a method 700 of rendering a webpage with an active element disabled, according to an example. Method 700 may be implemented by computing device 100 of FIGS. 1-2. Method 700 may include receiving a first request to access a webpage, at 702. For example, referring to FIG. 1. computing device 100 may receive first request 104 to access a webpage. Method 700 may also include transmitting a second request to a monitoring resource, at 704. For example, referring to FIG. 1, computing device 100 may transmit second request 106 to monitoring resource 108.

Method 700 may further include receiving an indication from the monitoring resource, at 706. For example, referring to FIG. 1, computing device 100 may receive indication 110 from monitoring resource 108. Method 700 may further include determining if the webpage is unsafe based on the indication, at 708,

In response to a determination that the webpage is unsafe, method 700 may further include obtaining a copy of the webpage from a host server, at 710. For example, referring to FIG. 2, computing device 100 may receive copy of webpage 202 from hosting server 200. Method 700 may further include rendering a modified copy of the webpage, at 712. For example, referring to FIG. 2, computing device 100 may render modified copy of the webpage 112.

In response to a determination that the webpage is not unsafe, method 700 may further include obtaining a copy of the webpage from a host server, at 14. Method 700 may further include rendering an unmodified copy of the webpage, at 716. For example, referring to FIG. 1, in response to receiving indication 110 that indicates the webpage is not unsafe, computing device 100 may render unmodified copy of the webpage 114.

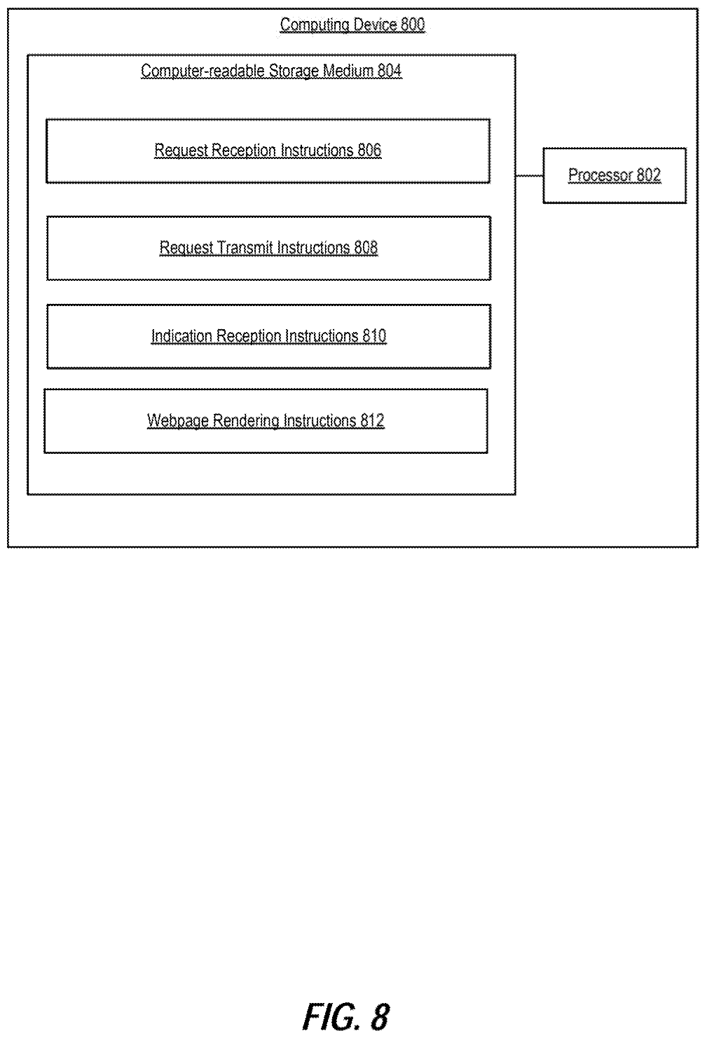

FIG. 8 illustrates a computing device 800 to render a webpage with an active element disabled, according to an example. Computing device 800 may implement computing device 100 of FIGS. 1-2. Computing device 800 may include a processor 802 and a computer-readable storage medium 804.

Processor 802 may be a central processing unit (CPU), a semiconductor-based microprocessor, and/or other hardware devices suitable for retrieval and execution of instructions stored in computer-readable storage medium 804. Processor 802 may implement processor 102 of FIGS. 1-2. Processor 802 may fetch, decode, and execute instructions 806, 808, 810, and 812 to control operations of computing device 800. As an alternative or in addition to retrieving and executing instructions, processor 802 may include at least one electronic circuit that includes electronic components for performing the functionality of instructions 806, 808, 810, 812, or a combination thereof.

Computer-readable storage medium 804 may be any electronic, magnetic, optical, or other physical storage device that contains or stores executable instructions. Thus, computer-readable storage medium 804 may be, for example, Random Access Memory (RAM), an Electrically Erasable Programmable Read-Only Memory (EEPROM), a storage device, an optical disc, etc. In some examples, storage medium 604 may be a non-transitory storage medium, where the term “non-transitory” does not encompass transitory propagating signals. Computer-readable storage medium 804 may be encoded with a series of processor executable instructions 806, 808, 810, and 812.

Request reception instructions 806 may receive a request to access a webpage. For example, referring to FIG. 1, computing device 100 may receive first request 124 to access a webpage.

Request transmit instructions 808 may transmit a request to determine if the webpage is unsafe. For example, referring to FIG. 1, computing device 100 may transmit second request 106 to monitoring resource 108 to determine if the webpage is unsafe.

Indication reception instructions 810 may receive an indication that indicates if the webpage is unsafe. For example, referring to FIG. 1, computing device 100 may receive indication 110 from monitoring resource 108.

Webpage rendering instructions 812 may render a webpage based on if the webpage is unsafe. For example, referring to FIG, 1, computing device 100 may render modified copy of the webpage 112 when the webpage is unsafe. Computing device 100 may render unmodified copy of the webpage 114 when the webpage is not unsafe. In some examples, instructions 806, 808, 810, 812 or a combination thereof may be implemented as a browser plug-in.

The use of “comprising”, “including” or “having” are synonymous and variations thereof herein are meant to be inclusive or open-ended and do not exclude additional unrecited elements or method steps.

What is claimed is:

1. A non-transitory computer-readable storage medium comprising instar tions that when executed cause a processor of a computing device to:
in response to receiving a first request to access a webpage, transmit a second request to a monitoring resource to determine if the webpage is unsafe;
receive, from the monitoring resource, an indication that he webpage is an unsafe webpage; and
in response to receiving the indication, render, at the computing device, a modified copy of the webpage with every active element of the webpage disabled.

2. The non-transitory computer-readable storage medium of claim 1, wherein an active element of the webpage includes a hyperlink, an embedded script, or a combination thereof.

3. The non-transitory computer-readable storage medium of claim 1, wherein the modified copy includes a display of a location of a hyperlink in the webpage.

4. The non-transitory computer-readable storage medium of claim 1, wherein the instructions when executed further cause the processor to display a message that the webpage is unsafe,

5. A non-transitory computer-readable storage medium co prising instructions that when executed cause a processor of a computing device to:
in response to receiving a first request to access a webpage, transmit a second request to a monitoring resource to determine if the webpage is unsafe;
receive, from the monitoring resource, an indication that the webpage is an unsafe webpage; and
in response to receiving the indication:
obtain a copy of the webpage from a hosting server;
identify a text field in the webpage; and
render, at the computing device, a modified copy of the webpage with the text field disabled.

6. The non-transitory computer-readable storage medium of claim 5, wherein the instructions when executed further cause the processor to:
after rendering the modified copy, receive an input to re-render the webpage; and
render a second copy of the webpage with thetext field enabled

7. The non-transitory computer-readable storage medium of claim 6, wherein the instructions when executed further cause the processor to:
store the input at the computing device; and
in response to receiving a third request to access the webpage, render a second modified copy of the webpage based on the input.

8. The non-transitory computer-readable storage medium of claim 6, wherein the instructions when executed further cause the processor to trans the input to the monitoring resource.

9. The non-transitory computer-readable storage medium of claim6, wherein the text field includes a password field.

10. A non-transitory computer-readable storage medium comprising instructions that when executed cause a processor of a computing device to:
in response to receiving a first request to access a webpage, transmit a second request to a monitoring resource to determine if the webpage is safe, wherein the webpage includes a first active element and a second active element;
receive, from the monitoring resource, an indication that the webpage is an unsafe webpage; and
in response to receiving the indication, render, at the computing device, a modified copy of the webpage based on user preference information, wherein the modified copy includes an enabled first active element and a disabled second active element.

11. The non-transitory computer-readable storage medium of claim 10, wherein the user preference information indicates the first active element is to be rendered as enabled.

12. The non-transitory computer-readable storage medium of claim 10, wherein the instructions when executed further cause the processor to update the user preference information to indicate the second active element is to be rendered as enabled in a subsequent rendering of the webpage at the computing device based on a selection of an option.

13. The non-transitory computer-readable storage medium of claim 10, wherein an active element of the webpage includes a hyperlink, an embedded script, a text field, or a combination thereof.

14. The non-transitory computer-readable storage medium of claim 10, wherein the instructions when executed further cause the processor to obtain a copy of the webpage from a hosting server.

15. The non-transitory computer-readable storage medium of claim 14, wherein the instructions when executed further cause the processor to render the modified copy based on the copy of the webpage.
